(19) United States
(12) Patent Application Publication
(10) Pub. No.: US 2014/0022988 A1
(43) Pub. Date: Jan. 23, 2014

(54) USER EQUIPMENT AND METHOD FOR ANTENNA PORT QUASI CO-LOCATION SIGNALING IN COORDINATED MULTI-POINT OPERATIONS

(71) Applicants: Alexei Davydov, Nizhny Novgorod (RU); Gregory V. Morozov, Nizhny Novgorod (RU); Alexander Maltsev, Nizhny Novgorod (RU); Ilya Bolotin, Nizhny Novgorod (RU); Debdeep Chatterjee, Santa Clara, CA (US)

(72) Inventors: Alexei Davydov, Nizhny Novgorod (RU); Gregory V. Morozov, Nizhny Novgorod (RU); Alexander Maltsev, Nizhny Novgorod (RU); Ilya Bolotin, Nizhny Novgorod (RU); Debdeep Chatterjee, Santa Clara, CA (US)

(21) Appl. No.: 13/706,098

(22) Filed: Dec. 5, 2012

Related U.S. Application Data
(60) Provisional application No. 61/674,274, filed on Jul. 20, 2012.
(60) Provisional application No. 61/707,784, filed on Sep. 28, 2012.

(51) Int. Cl. H04W 88/02

(52) U.S. Cl. CPC H04W 88/02
USPC 370/328

(57) ABSTRACT

User Equipment (UE) and methods for antenna port quasi co-location signaling in coordinated multi-point (CoMP) operations are generally described herein. In some embodiments, one or more downlink channels are at least partially offloaded from a serving Evolved Node-B (eNB) to one or more neighbor eNBs. The UE may receive signaling from the serving eNB to indicate a reference signal of a neighbor eNB to use for estimation of one or more large-scale physical-layer parameters associated with the one or more downlink channels provided by one of more of the neighbor eNB. The UE may estimate the one or more large-scale physical-layer parameters based on receipt of the indicated reference signal from the neighbor and serving eNBs. The UE may also apply the estimated one or more large-scale physical-layer parameters for processing the one or more downlink channels from the neighbor and serving eNBs.

### RELATED APPLICATIONS

This application claims the benefit of priority under 35 U.S.C. 119(e) to U.S. Provisional Patent Application Ser. No. 61/674,274, filed on Jul. 20, 2012, and to U.S. Provisional Patent Application Ser. No. 61/707,784, filed on Sep. 28, 2012, both of which are incorporated herein by reference in their entireties.

### TECHNICAL FIELD

Embodiments pertain to wireless communications. Some embodiments relate to coordinated multipoint (CoMP) operations in cellular networks, such as E-UTRAN networks operating in accordance with one of the 3GPP standards for the Long Term Evolution (LTE) (3GPP LTE).

### BACKGROUND

By coordinating and combining signals from multiple antenna locations, CoMP operations may make it possible for mobile users to enjoy consistent performance and quality when they access and share videos, photos and other high-bandwidth services whether they are close to the center of a cell or at its outer edges. During CoMP operations, user equipment (UE) may receive signals from multiple sites (e.g., a serving enhanced node B (eNB) and a neighbor eNB) to take advantage of multiple reception to improve link performance. One issue with CoMP operations is that it becomes difficult for a UE to process signals received from a neighbor eNB due to a mismatch in some of the parameters between the serving and neighbor eNBs.

Thus, what are needed are UEs and methods for signaling in CoMP operations to allow a UE to address parameter mismatch for improved CoMP operations.

### BRIEF DESCRIPTION OF THE DRAWINGS

FIG. 1 illustrates a wireless network in accordance with some embodiments;

FIG. 2 illustrates timing mismatch in accordance with some embodiments;

FIG. 3 is a functional block diagram of user equipment (UE) in accordance with some embodiments;

FIGS. 4A through 4C illustrate various CoMP scenarios in accordance with some embodiments; and

FIG. 5 is a procedure for antenna port quasi co-location signaling for CoMP operations in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

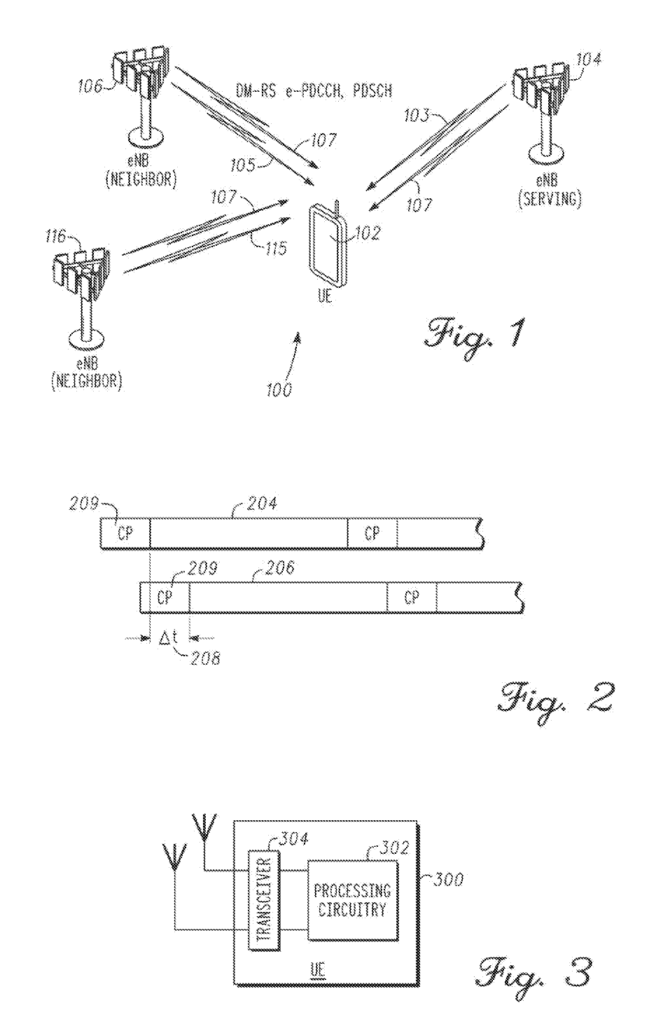

FIG. 1 illustrates a wireless network in accordance with some embodiments. Wireless network 100 includes user equipment (UE) 102 and a plurality of enhanced node Bs (eNBs) 104, 106 and 116. The eNBs may provide communication services to UEs, such as UE 102. The eNB 104 may be a serving eNB when the UE 102 is located with a region e.g., a cell) served by eNB 104. The eNBs 106, 116 may be neighbor eNBs.

In accordance with embodiments, UE 102 may be configured for coordinated multi-point (CAW) operations in which one or more downlink channels 107 are at least partially offloaded from the serving eNB 104 to one or more neighbor eNBs, such as neighbor eNBs 106 and/or 116. In these embodiments, the UE 102 may receive signaling from the serving eNB 104 to indicate a particular reference signal of a neighbor eNB (e.g., reference signal 105 of neighbor eNB 106, and/or reference signal 115 of neighbor eNB 116) to use for estimation of one or more large-scale physical-layer parameters associated with the one or more downlink channels 107 that may be provided at least in part by the neighbor eNB, The UE 102 may estimate the one or more large-scale physical-layer parameters based on receipt of the indicated reference signal 105 from the neighbor eNB and may apply the estimated one or more large-scale physical-layer parameters for processing the one or more downlink channels 107 from the neighbor eNB. Accordingly, mismatch between these parameters may be addressed. For example, improved symbol detection and demodulation of an offloaded downlink channel transmitted by a neighbor eNB may be achieved.

This is unlike some conventional techniques which may estimate one or more of the large-scale physical-layer parameters based on a reference signal 103 from the serving eNB 104 for processing a downlink channel that has been at least partially offloaded. Conventional estimation of any one or more of these large-scale physical-layer parameters based on reference signals (e.g., reference signal 103) sent by the serving eNB 104 may result in poor performance.

In some embodiments, the one or more downlink channels 107 may be simultaneously offloaded to two or more neighbor eNBs, such as neighbor eNB 106 and neighbor eNB 116. In these embodiments, the serving eNB 104 may provide signaling to the UE 102 to indicate the particular reference signal 105 of neighbor eNB 106 to use for estimation of one or more large-scale physical-layer parameters associated with the one or more downlink channels 107 that may be provided at least in part by neighbor eNB 106, and the serving eNB 104 may provide signaling to indicate the particular reference signal 115 of neighbor eNB 116 to use for estimation of one or more large-scale physical-layer parameters associated with the one or more downlink channels 107 that may be provided at least in part by neighbor eNB 116. As discussed in more detail below, the one or more downlink channels 107 may be either fully offloaded to neighbor eNBs 106 and 116, or partially offloaded to neighbor eNBs 106 and 116.

The large-scale physical-layer parameters may include a timing offset, frequency offset or shift, channel power delay profile, channel Doppler spread, and average channel gain, although the scope of the embodiments is not limited in this respect. Other large-scale physical-layer parameters, such as delay spread, Doppler shift, and average delay, may also be included.

In some embodiments, the UE 102 is configured for CoMP operations in an Evolved Universal Terrestrial Radio Access Network (E-UTRAN) and the indicated reference signal 105, 115 may be a channel state information reference signal (CSI-RS) of a CoMP measurement set or one of a cell-specific reference signal (CRS), a Primary Synchronization Sequence (PSS) and Secondary Synchronization Sequence (SSS). The CoMP measurement set may be a set of CSI-RSs which UE 102 may use to perform CSI measurements and provide feedback to an eNB. The one or more downlink channels 107 that are at least partially offloaded from the serving eNB 104 to the one or more neighbor eNBs 106, 116 may include a physical downlink shared channel (PDSCH) and/or an enhanced physical downlink control channel (e-PDCCH). In these embodiments, the UE 102 may apply the estimate of the one or more large-scale physical-layer parameters for processing the downlink channel 107 that is offloaded (i.e., PDSCH and/or the e-PDCCH) and received from one or more neighbor eNBs 106, 116.

In some embodiments, the neighbor eNB 106 and/or the neighbor eNB 116 may be associated with a pico cell while the serving eNB 104 may be associated with a macro cell, although the scope of the embodiments is not limited in this respect. In various CoMP scenarios described in more detail below, remote radio heads (RRHs) may perform the CoMP operations of a neighbor eNB.

In fully-offloaded CoMP embodiments, one or more downlink channels 107 may be completely offloaded to one or more neighbor eNBs, such as neighbor eNB 106 and neighbor eNB 116. In these full offloaded CoMP embodiments, the downlink channel that is fully-offloaded may be transmitted by the one or more neighbor eNBs 106, 116 and is not transmitted by the serving eNB 104. In these fully-offloaded embodiments, the e-PDCCH and/or the PDSCH, for example, may be completely offloaded to one or more neighbor eNBs, such as neighbor eNB 106 and/or neighbor eNB 116. The e-PDCCH and/or the PDSCH, for example, may alternatively be completely offloaded to two neighbor eNBs, such as neighbor eNB 106 and neighbor eNB 116. The e-PDCCH and/or the PDSCH, for example, may alternatively be completely offloaded to three neighbor eNBs, such as neighbor eNB 106, neighbor eNB 116 and another neighbor eNB (not illustrated).

In partially-offloaded CoMP embodiments, one or more downlink channels 107 may be partially offloaded to one or more neighbor eNBs, such as neighbor eNB 106 and/or neighbor eNB 116. In these partially-offloaded CoMP embodiments, the downlink channel that is partially offloaded is transmitted concurrently by the serving eNB 104 and by the one or more neighbor eNBs. In these partially-offloaded embodiments, the serving eNB 104 may indicate that the downlink channel (e.g., the e-PDCCH and/or the PDSCH) is sent from the serving eNB 104 as well from one or more neighbor eNBs, such as neighbor eNB 106 and/or neighbor eNB 116. This allows the UE 102 to additionally use one or more large-scale physical-layer parameters estimated from one or more reference signals (e.g., PSS/SSS/CRS or CSI-RS) of serving eNB 104 for downlink channel processing (i.e., in addition to one or more reference signals (e.g., PSS/SSS/CRS or CSI-RS) of a neighbor eNB 10 downlink channel processing).

In some partially-offloaded COMP embodiments, a downlink channel (i.e., the e-PDCCH and/or PDSCH) may be partially offloaded to two neighbor eNBs allowing the UE to receive a downlink channel from three eNBs (e.g., serving eNB 104, neighbor eNB 106 and neighbor eNB 116). In some of these embodiments, network may be an E-UTRAN and may operate in accordance with one or more of the 3GPP LTE specifications, release 11 or later, although this is not a requirement.

In some embodiments, the UE 102 may apply the estimate of the one or more large-scale physical-layer parameters (i.e., estimated from reference signal 105 and/or reference signal 115) for receipt of a user-specific reference signal (UE-specific RS) from a neighbor eNB (e.g., neighbor eNB 106 and/or neighbor eNB 116) and use the UE-specific RS to demodulate regions of the downlink channel 107 that are received from the neighbor eNB. Additionally, in partially-offloaded embodiments, the UE 102 may apply an estimate of the one or more large-scale physical-layer parameters (i.e., estimated from reference signal 103) for receipt of a UE-specific RS from the serving eNB 104 and use the UE-specific RS to demodulate regions of the downlink channel 107 that are received from the serving eNB 104.

The UE-specific RS may include an e-PDCCH UE-specific RS and/or a PDSCH UE-specific RS. The e-PDCCH UE-specific RS may be used by the UE 102 for demodulation of the e-PDCCH, The PDSCH UE-specific RS may be used by the UE 102 for demodulation of the PDSCH. The UE-specific RS may be a demodulation reference signal (DM-RS).

In an example embodiment, the serving eNB 104 may indicate that the e-PDCCH is being sent from both the serving eNB 104 as well as from two or more neighbor eNBs (e.g., neighbor eNB 106 and neighbor eNB 116). The serving eNB 104 may indicate to the UE 102 to use reference signal 105 to estimate one or more large-scale physical-layer parameters of neighbor eNB 106 and to use reference signal 115 to estimate one or more large-scale physical-layer parameters of neighbor eNB 116. The estimated one or more large-scale physical-layer parameters of neighbor eNB 106 may be used to receive a UE-specific RS from eNB 106 which may be used for demodulation and processing of the e-PDCCH from eNB 106. The estimated one or more large-scale physical-layer parameters of neighbor eNB 116 may be used to receive a UE-specific RS from eNB 116 which may be used for demodulation processing of the e-PDCCH from eNB 116. A similar approach may be applied when the PDSCH is at least partially offloaded.

In some embodiments, the estimate of the one or more large-scale physical-layer parameters may, for example, be used for symbol detection and demodulation, although the scope of the embodiments is not limited in this respect. In some embodiments, the estimate of the one or more large-scale physical-layer parameters may be used for channel estimation based on a UE-specific RS for the offloaded channel (i.e., the e-PDCCH UE-specific RS or the PDSCH UE-specific RS).

FIG. 2 illustrates timing mismatch in accordance with some embodiments. As shown in FIG. 2, frames 204 may be received from a serving eNB, such as serving eNB 104 (FIG. 1), and frames 206 may be received from a neighbor eNB, such as neighbor eNB 106 (FIG. 1). A timing offset 208 may exist between frames 204 and 206 due to different propagation distances between the serving eNB 104 and UE 102 (FIG. 1) and between the neighbor eNB 106 and the UE 102.

In accordance with embodiments, when the large-scale physical layer parameters include a timing offset, such as timing offset 208, the signaling received from the serving eNB 104 may indicate that the reference signal 105 of the neighbor eNB 106 that is to be used for timing estimation associated with the one or more downlink channels 107 of the neighbor eNB 106. In these embodiments, the UE 102 may perform initial timing synchronization based on receipt of a synchronization sequence (e.g., the PSS and/or the SSS) of the serving eNB 104. The UE 102 may then estimate a timing offset 208 between downlink frames 204 of the serving eNB 104 and downlink frames 206 of the neighbor eNB 106 based on receipt of a reference signal 103 from the serving eNB 104 and the indicated reference signal 105 of the neighbor eNB 106. The UE 102 may apply the estimated timing offset for processing one or more downlink channels 107 provided by the neighbor eNB 106. As illustrated in FIG. 2, the timing offset 208 may be limited to the length of the cyclic prefix (CP) 209.

In some embodiments, the signaling from the serving eNB 104 may also indicate that a reference signal from the neighbor eNB 106 is to be used for timing estimation when a particular downlink channel (e.g., the e-PDCCH) is also sent by the neighbor eNB 106. In these CoMP embodiments, the UE 102 may use the e-PDCCH UE-specific RS from the neighbor eNB 106 to process the e-PDCCH received from the neighbor eNB 106, even though there is a timing mismatch between a reference signal (e.g., the CRS) of the serving eNB 104 and the e-PDCCH of the neighbor eNB 106 since the timing offset has been estimated and compensated by the UE 102. By compensating for any timing mismatch between a reference signal of the serving eNB 104 (e.g., the CRS) and a reference signal from the neighbor eNB 106 (e.g., the e-PDCCH UE-specific RS for e-PDCCH processing), any negative impact of such timing mismatch may be avoided.

In some embodiments, a channel estimation procedure may be performed on a UE-specific RS that is sent by neighbor eNB 106. Estimates of the large-scale physical-layer parameters, for example, may be used by the UE 102 for UE-specific RS channel estimation procedures.

in some embodiments, the one or more downlink channels that are at least partially offloaded may be partitioned into regions or sets. Each region may be sent by one of the eNBs participating in CoMP operations. The UE 102 may receive signaling from the serving eNB 104 indicating which resource blocks comprise the region of the one or more downlink channels (e.g., e-PDCCH and/or the PDSCH) that are transmitted from the serving eNB 104. The UE 102 may also receive signaling indicating the resource blocks that comprise the region of the one or more downlink channels that are transmitted by the one or more neighbor eNBs. In these embodiments, the UE 102 may apply a different processing (i.e., for the one or more large-scale physical layer parameters including application of timing offset compensation) to each region of the offloaded downlink channel independently.

In some embodiments, the regions of the e-PDCCH may be referred to as sets. In some embodiments, the regions of the PDSCH may be a resource block allocation.

In some embodiments, when the e-PDCCH includes multiple regions (i.e., sets), the CSI-RS resource may be configured or indicated for each region (or set) of the e-PDCCH that is sent to be specific to an eNB that is participating in the CoMP operations. In these embodiments, multiple e-PDCCH region configurations may be sent to UE 102. Each configuration may have its own reference signal configuration or indication, an example of which is illustrated below:

e-PDCCH-Config-Set-r11 ::= CHOICE {
...
csiRsIndex-r11 INTEGER (0..3),
physCellId-r11 PhysCellId,
...
}

In this example, a CSI-RS index is used instead of a configuration of CSI-RS. The CSI-RS index points to a particular CSI-RS which is configured by a control message.

In some embodiments, the UE 102 may calculate CSI feedback based on the CSI-RSs (i.e., of the CoMP measurement set) of each eNB involved in the COMP operations (including the serving eNB 104 and one or more neighbor eNBs). The UE 102 may transmit the CSI feedback to the serving eNB 104. In some of these embodiments, the CSI feedback for the neighbor eNB may, for example, be sent to the serving eNB 104 (over an X2 interface). In some embodiments, a set of CSI-RS of the CoMP measurement set may be configured for the UE 102 and provided by the serving eNB 104.

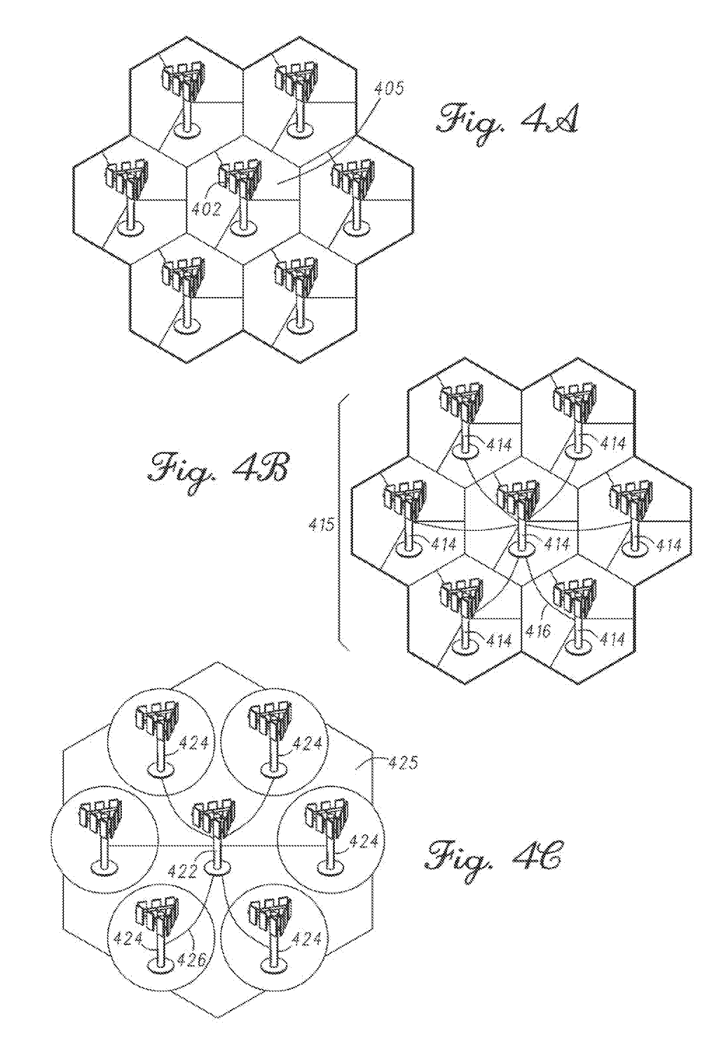

FIG. 3 is a functional block diagram of a UE in accordance with some embodiments. UE 300 may be suitable for use as UE 102 (FIG. 1) although other UE configurations may also be suitable. UE 300 may include a transceiver 304 for communicating with at least two or more eNBs and processing circuitry 302 configured to perform at least some of the operations described herein. UE 300 may also include a memory and other elements not separately illustrated. The processing circuitry 302 may also be configured to determine several different feedback values discussed below for transmission to an eNB. The processing circuitry may also include a media access control (MAC) layer. In some embodiments, the UE 300 may include one or more of a keyboard, a display, a non-volatile memory port, multiple antennas, a graphics processor, an application processor, speakers, and other mobile device elements. The display may be an LCD screen including a touch screen.

In accordance with some embodiments, the processing circuitry 302 may be configured to estimate the one or more large-scale physical-layer parameters based on receipt of an indicated reference signal from the one or more neighbor eNBs. For example, the UE 300 may estimate a first timing offset from receipt of reference signal 105 from neighbor eNB 106 and may estimate a second timing offset from receipt of reference signal 115 from neighbor eNB 116. The processing circuitry 302 may apply the estimated timing offsets for processing the one or more downlink channels 107 from the neighbor eNBs. For example, the processing circuitry 302 may apply the first timing offset estimated from reference signal 105 for receipt of a UE-specific RS from neighbor eNB 106 (e.g., the e-PDCCH specific RS) and use the UE-specific RS from neighbor eNB 106 to demodulate the regions of the downlink channel (e.g., the particular sets of the e-PDCCH) received from the neighbor eNB 106. Furthermore, the UE 102 may apply the second timing offset estimated from reference signal 115 for receipt of a UE-specific RS from neighbor eNB 116 (e.g., the e-PDCCH UE-specific RS) and use the UE-specific RS from neighbor eNB 116 to demodulate the regions of the downlink channel (e.g., the particular sets of the e-PDCCH) received from the neighbor eNB 116. Additionally, the processing circuitry 302 may apply the timing estimated from reference signal 103 for receipt of a UE-specific RS from serving eNB 104 (e.g., the e-PDCCH UE-specific RS) and use the UE-specific RS from serving eNB 104 to demodulate the regions of the downlink channel (e.g., the particular sets of the e-PDCCH) received from the serving eNB 104.

In accordance with embodiments, rather than estimating one or more of the large-scale physical-layer parameters based on a reference signal 103 from the serving eNB 104, such as the CRS, for symbol detection and demodulation of the e-PDCCH and/or PDSCH transmitted by the neighbor eNB 106, the UE 300 may estimate one or more large-scale physical-layer parameters based on receipt of the indicated reference signal 105 of the neighbor eNB 106 for symbol detection and demodulation of the e-PDCCH and/or PDSCH transmitted by the neighbor eNB 106. Accordingly, improved symbol detection and demodulation of the e-PDCCH and/or PDSCH transmitted by the neighbor eNB 106 may be achieved. Conventional estimation of any one or more of these large-scale physical-layer parameters based on reference signals sent by the serving eNB 104 may result in poor performance.

The one or more antennas utilized by the UE 300 may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result between each of antennas and the antennas of a transmitting station.

Although the UE 300 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

In some embodiments, the UE 300 may be configured to transmit and receive OFDM communication signals over a multicarrier communication channel in accordance with an OFDMA communication technique. The OFDM signals may comprise a plurality of orthogonal subcarriers. In some LTE embodiments, the basic unit of the wireless resource is the Physical Resource Block (PRB). The PRB may comprise 12 sub-carriers in the frequency domain×0.5 ms in the time domain. The PRBs may be allocated in pairs (in the time domain). In these embodiments, the PRB may comprise a plurality of resource elements (REs). A RE may comprise one sub-carrier×one symbol.

In some embodiments, the UE 300 may be part of a portable wireless communication device, such as a personal digital assistant (PDA), a laptop or portable computer with wireless communication capability, a web tablet, a wireless telephone, a wireless headset, a pager, an instant messaging device, a digital camera, an access point, a television, a medical device (e.g., a heart rate monitor, a blood pressure monitor, etc.), or other device that may receive and/or transmit information wirelessly.

In some UTRAN LTE embodiments, the UE 300 may calculate several different feedback values which may be used to perform channel adaption for closed-loop spatial multiplexing transmission mode. These feedback values may include a channel-quality indicator (CQI), a rank indicator (RI) and a precoding matrix indicator (PMI). By the CQI, the transmitter selects one of several modulation alphabets and code rate combinations. The RI informs the transmitter about the number of useful transmission layers for the current MIMO channel, and the indicates the codebook index of the precoding matrix (depending on the number of transmit antennas) that is applied at the transmitter. The code rate used by the eNB may be based on the CQI. The PMI may be a vector or matrix that is calculated by the UE and reported to the eNB. In some embodiments, the UE may transmit a physical uplink control channel (PUCCH) of format 2, 2a or 2b containing the CQI/PMI or RI.

FIGS. 4A through 4C illustrate various CoMP scenarios in accordance with some embodiments. CoMP scenario one is illustrated in FIG. 4A in which a homogeneous network performs intra-site CoMP operations. In this scenario, each eNB 402 may perform intra-site CoMP within its coordination area 405, which may be within the cell that it serves. CoMP scenario two is illustrated in FIG. 4B in which a homogeneous network with high-power remote radio heads (RRHs) 412 that perform CoMP operations within a coordination area 415. In CoMP scenario two, the RRHs 414 may be coupled by high-bandwidth links 416, such as optical fiber links. The coordination area 415 may comprise a plurality of cells.

CoMP scenarios three and four are illustrated in FIG. 4C in which a heterogeneous network includes lower-power RRHs 424 that perform CAW operations within a higher-power eNB 422 providing macrocell coverage area 425 where transmission and reception points are provided by the RRHs 424 and higher-power eNB 422. In CoMP scenarios three and four, a single eNB 422 may coordinate CoMP operations within the coverage area 425. In CoMP scenario three, the RRHs 424 may have different cell IDs than the macrocell. In CoMP scenario four, the RRHs 424 may have the same cell ID as the cell ID of the macrocell. In CoMP scenarios three and four, the RRHs 424 may be coupled to the eNB 422 by high-bandwidth links 426, such as optical fiber links. Each RRH 424 may provide communications within a micro or pico cell as illustrated.

In CoMP scenarios one through four, the e-PDCCH UE-specific RS antenna ports may be linked via signaling with one of the CSI-RS of the CoMP management set. In some embodiments for CoMP scenarios one through three, the e-PDCCH UE-specific RS may be linked (by physical cell identity configuration) with other cell reference signals (e.g., PSS/SSS/CRS) to provide a timing reference (or a reference to one or more other large scale properties) for e-PDCCH processing. The linkage of a UE-specific RS to some other reference signal (e.g., CSI-RS, PSS, SSS, or CRS) allows usage of estimated timing (or other large-scale physical-layer parameter) on the indicated reference signals for the subsequent e-PDCCH processing.

For the CoMP measurement set (which may include CSI-RS from the serving eNB 104 and CSI-RS from the neighbor eNB 106), the UE 102 may provide CSI feedback based on receipt of CSI-RSs from each eNB involved in the CoMP operations. For the CoMP resource management set, the UE provides more basic information such as reference signal received power.

In some embodiments, the serving eNB 104 provides the CSI feedback for a neighbor eNB 106 to the neighbor eNB over the backhaul network (e.g., the X2 interface) for use by the neighbor eNB 106 for configuring the UE-specific RS (i.e., e-PDCCH UE-specific RS and the PDSCH UE-specific RS). Alternatively, rather than the serving eNB 104, a master eNB or central processing unit may perform all CoMP processing.

In some embodiments, the UE 102 may calculate CSI feedback based on CSI-RS of the serving eNB 104 and transmit the CSI feedback (for the serving eNB) to the serving eNB 104, and the UE may calculate CSI feedback (for the neighbor eNB) based on CSI-RS of one or more neighbor eNB 106 involved in the CoMP operations and transmit the CSI feedback (for the neighbor eNB) to the serving eNB 104.

In some embodiments, the UE 102 may use channel information determined from the e-PDCCH UE-specific RS for symbol detection and demodulation of the e-PDCCH. The UE-specific RS are UE-specific reference signals and in these embodiments, an eNB may transmit a UE-specific RS in every resource block (RB) within a resource allocation after multiplication by the beamforming matrix for a corresponding UE. The eNB may use the CSI feedback from the UE to generate the beamforming matrix. In these embodiments, the UE 102 may use the e-PDCCH UE-specific RS from the neighbor eNB 106 for demodulation and symbol detection of the e-PDCCH received from the neighbor eNB 106, and the UE 102 may use the PDSCH UE-specific RS from the neighbor eNB 106 for demodulation and symbol detection of the PDSCH received from the neighbor eNB 106.

In some embodiments, the UE 102 may be configured for single fast-Fourier transform (FFT) processing to process signals of different eNBs (e.g., the CSI-RSs, CRSs, e-PDCCH regions (sets), resource blocks of the PDSCH and the UE-specific RSs) in a single FFT processing step. In CoMP operations, although the PDSCH, e-PDCCH, PDCCH, CRS, as well as other signals may be sent from different eNBs, the UE 102 may use a single FFT operation which may be configured to correspond to the timing of the CRS from serving eNB 104. In this way, the possible mismatches between parameter of other reference signals and channels (transmitted by neighbor eNBs 106) may be individually compensated in frequency domain after FFT. Alternatively, the UE 102 may take multiple FFTs (i.e., for the same OFDM symbols) corresponding to the received timing of each channel or reference signal, however this may result in additional processing complexity. In some embodiments, the processing circuitry 302 of UE 300 (FIG. 3) may be configured to perform FFT operations.

In some embodiments, the signaling provided from the serving eNB 104 to indicate a reference signal of a neighbor eNB 106 (i.e., reference signal 105 of neighbor eNB 106 and/or reference signal 115 of neighbor eNB 116) to use for estimation of one or more large-scale physical-layer parameters associated with the one or more downlink channels 107 provided by one of more of the neighbor eNBs, may be provided using radio-resource control (RRC) layer signaling. In these embodiments, the RRC layer signaling may indicate the configuration of a reference CSI-RS resource index of a CoMP resource management set or a configuration of a reference physical cell identity of a reference signal (e.g., the PSS/SSS/CRS) of a neighbor eNB. In some of these embodiments, another set of CSI-RS resources may be configured for the UE 102 as part of the CoMP measurement set. In this case, the CoMP measurement set can be also used for configuration of the reference CSI-RS resource.

The following is an example for configuring the e-PDCCH:

e-PDCCH-Config-r11 ::= CHOICE {
...
measSetCsiRsIndex-r11 INTEGER (0..3),
physCellId-r11 PhysCellId,
...
}

In some of these embodiments, the linkage (or co-location signaling) performed using RRC layer signaling may include the configuration of the reference CSI-RS resource index of the CoMP resource management set as shown in the following example or may include configuration of the reference physical cell identify of the other cell's PSS/SSS/CRS.

### Example

e-PDCCH-Config-r11 ::= CHOICE {
...
managmentCsiRsIndex-r11 INTEGER (0..31),
physCellId-r11 PhysCellId,
...
}

In some alternate embodiments, the signaling to indicate the reference signal of the one or more neighbor eNBs to use for estimation of one or more large-scale physical-layer parameters may be provided using MAC layer signaling, although the scope of the embodiments is not limited in this respect.

In some embodiments, when the PDSCH is at least partially offloaded, signaling for the PDSCH is provided using physical (PHY) layer signaling in the downlink control information (DCI). In these embodiments, DCI-based signaling may be used as PDSCH decoding is performed after DCI decoding. On the other hand, DCI-based signaling may not be as feasible for the e-PDCCH since e-PDCCH decoding may be performed before DCI decoding the e-PDCCH may be first processed to decode the DCI).

In some embodiments, the reference signal indicated for large scale physical layer parameter estimation (including, for example, timing estimation) may be configured independently for each different e-PDCCH region or set. It may also be configured independently for common and UE-specific search spaces, localized and distributed e-PDCCH allocations. In some embodiments, the indicated reference signal may be also used for other purposes in e-PDCCH processing such as frequency offset compensation, SINR, Doppler and power delay profile estimation for channel estimation. In some embodiments, if the indication or signaling is not provided, UE 102 may be configured to use a default parameter estimation (including a default timing) derived from a reference signal (e.g., the PSS/SSS/CRS) of the serving eNB 104.

In some embodiments, the CSI-RS of the CoMP measurement set may be considered for co-location signaling. In these embodiments, the CSI-RS index may be RRC signaled as a part of e-PDCCH configuration to indicate the particular co-located CSI-RS resource of COMP measurement set for e-PDCCH UE specific RS processing. The estimated power delay profile, timing, frequency offset and/or Doppler spread estimated on the CSI-RS of indicated or configured CSI-RS may be used by the UE 102 for e-PDCCH processing.

Alternatively, the CSI process which includes the CSI-RS index and an interference measurement resource (IMR) such as a CSI interference measurement (CSI-IM) may be used for co-location signaling. In these embodiments, interference estimated on the IMR (in addition to power delay profile, timing, frequency offset and/or Doppler spread estimated on CSI-RS) may be used to predict the expected interference and SINR which is observed on e-PDCCH UE-specific RS. In these embodiments, the CSI process index may be signaled to the UE (instead of CSI-RS index) using RRC signaling as a part of e-PDCCH region or set configuration.

For CRS co-location signaling a value of a UE-specific RS scrambling initialization seed may be used to indicate physical cell ID of CRS for co-location. This signaling may be implicit and may note require new fields in e-PDCCH for UE-specific RS co-location signaling. In these embodiments, the co-location signaling described above may be different for different e-PDCCH regions/sets, localized and distributed e-PDCCH allocations, as well as common and UE-specific search space.

In some embodiments, the PSS and SSS may provide the UE 102 with its physical layer identity within the cell. These signals may also provide frequency and time synchronization within the cell. The PSS may be constructed from Zadoff-Chu (ZC) sequences and the length of the sequence may be predetermined (e.g., 62) in the frequency domain. The SSS may use two interleaved sequences (i.e., maximum length sequences (MLS), shift-register generated (SRG) sequences or m-sequences) which are of a predetermined length (e.g., 31). The SSS may be scrambled with the PSSs that determine physical layer ID. The SSS may provide the LTE with information about the cell ID, frame timing properties and the cyclic prefix (CP) length. The UE 102 may also be informed whether to use time-division duplexing (TDD) or frequency-division duplexing (FDD), in FDD, the PSS may be located in the last OFDM symbol in first and eleventh slot of the frame, followed by the SSS in the next symbol. In TDD, the PSS may be sent in the third symbol of the 3rd and 13th slots while SSS may be transmitted three symbols earlier. The PSS may provide the UE 102 with information about to which of the three groups of physical layers the cell belongs to (e.g., 3 groups of 168 physical layers). One of 168 SSS sequences may be decoded right after PSS and defines the cell group identity directly.

In some embodiments, the UE 102 may be configured in one of ten “transmission modes” for PDSCH reception: Mode 1: Single antenna port, port 0; Mode 2: Transmit diversity; Mode 3: Large-delay CDD; Mode 4: Closed-loop spatial multiplexing; Mode 5: MU-MIMO; Mode 6: Closed-loop spatial multiplexing, single layer; Mode 7: Single antenna port, UE-specific RS (port 5); Mode 8, 9, 10: Single or dual-layer transmission with UE-specific RS (ports 7 and/or 8).

In some embodiments, the CSI-RS may be used by the UE 102 for channel state information measurements (e.g., for CQI feedback). In some embodiments, the CSI-RS may be transmitted periodically in particular antenna ports (e.g., up to eight transmit antenna ports) at different subcarrier frequencies (assigned to the UE) for use in estimating a MIMO channel. In some embodiments, a UE-specific reference signal may be precoded in the same way as the data when non-codebook-based precoding is applied, although this is not a requirement.

In accordance with embodiments, the term “antenna port” may refer to a logical antenna of an eNB which may correspond to one or more physical antennas of one or more eNBs (or RRHs). The correspondence between antenna ports and physical antennas may depend on the specific eNB implementation. For example, one logical antenna port may constitute transmission from multiple physical antennas with beamforming where the UE 102 may not be aware about the actual beamforming and/or mapping between logical and physical antennas used by the eNB. In some embodiments, an antenna port may be the logical antenna on which the channel estimation may be performed by the UE 102. In some embodiments, there may be one to one mapping between one physical antenna and one antenna port, although this is not a requirement.

In accordance with some embodiments, two antenna ports may be considered quasi co-located if the large-scale physical-layer properties of the channel over which a symbol on one antenna port is conveyed can be inferred from the channel over which a symbol on the other antenna port is conveyed. In some embodiments, the CRS may be transmitted using antenna ports 0, 1, 2, 3, the CSI-RS may be transmitted using antenna ports 15, 16, 17, 18, 19, 20, 21, 22, the UE-specific RS may be transmitted using antenna ports 7, 8, and the e-PDCCH UE-specific RS may be transmitted using antenna ports 107, 108, 109, 110, although the scope of the embodiments is not limited in this respect.

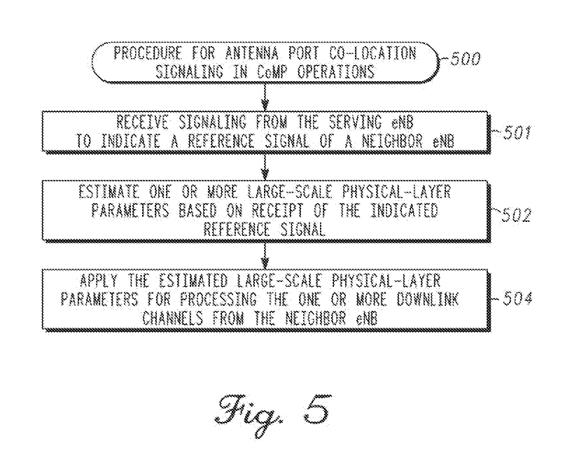

FIG. 5 is a procedure for antenna port quasi co-location signaling for CoMP operations in accordance with some embodiments. Procedure 500 may be performed a UE, such as UE 102 (FIG. 1), for CoMP operations.

In operation 501, the UE 102 may receive signaling from the serving eNB 104 (FIG. 1) to indicate one or more reference signals (i.e., reference signal 105 of neighbor eNB 106 and/or reference signal 115 of neighbor eNB 116) to use for independent estimation of one or more large-scale physical-layer parameters (e.g., timing offset) associated with the one or more downlink channels 107 (FIG. 1) that are at least partially offloaded and provided by one or more neighbor eNBs.

In operation 502, the UE 102 may estimate the one or more large-scale physical-layer parameters based on receipt of the indicated reference signal from the one or more neighbor eNBs. For example, the UE 102 may independently estimate a first timing offset from receipt of reference signal 105, and may independently estimate a timing offset from receipt of reference signal 115.

In operation 504, the UE 102 may apply the estimated one or more large-scale physical-layer parameters for processing the one or more downlink channels 107 from the neighbor eNBs. For example, the UE 102 may apply the first timing offset estimated from reference signal 105 for receipt of a UE-specific RS from neighbor eNB 106 (e.g., the e-PDCCH UE-specific RS) and use the UE-specific RS from neighbor eNB 106 to demodulate the regions of the downlink channel (e.g., the e-PDCCH) received from the neighbor eNB 106. Furthermore, the UE 102 may apply the second timing offset estimated from reference signal 115 for receipt of a UE-specific RS from neighbor eNB 116 (e.g., the e-PDCCH UE-specific RS) and use the UE-specific RS from neighbor eNB 116 to demodulate the regions of the downlink channel (e.g., the e-PDCCH) received from the neighbor eNB 116. In this example, after demodulation of the regions or sets of the downlink channel received from the serving eNB 104 and the neighbor eNBs, the demodulated information may be combined providing improved reception and/or bandwidth.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, UE 300 (FIG. 3) may include one or more processors and may be configured with instructions stored on a computer-readable storage device.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

1.-21. (canceled)

22. User Equipment (UE) arranged to:
receive signaling from a serving Evolved Node B (eNB) indicating a transmission mode for receiving a downlink channel, the transmission mode indicating that a first set of antenna ports and a second set of antenna ports are quasi co-located;
estimate a member of a set of large scale parameters for the first set of antenna ports, members of the set of large scale parameters including at least one of Doppler shift, Doppler spread, average delay, or delay spread; and
apply the estimated member of the set of large scale parameters to operations of the second set of antenna ports based on the indication of quasi co-location between the first set of antenna ports and the second set of antenna ports.

23. The UE of claim 22, wherein the channel is an Enhanced Physical Downlink Control Channel (e-PDCCH), wherein the operations of the second set of antenna ports include decoding the e-PDCCH, and wherein members of the second set of antenna ports are antenna ports 107-110.

24. The UE of claim 23, wherein members of the first set of antenna ports are antenna ports 0-3.

25. The UE of claim 23, wherein the transmission mode is transmission mode 10, and wherein members of the first set of antenna ports are antenna ports 15-22.

26. The UE of claim 22, wherein the signaling includes indication of a reference signal, and wherein to estimate the member of the set of large scale parameters includes using the reference signal for the estimation.

27. The UE of claim 26, wherein the reference signal is a channel-state information reference signal (CSI-RS).

28. The UE of claim 26, wherein the indication of the reference signal includes a reference to a reference signal of a neighboring eNB.

29. The UE of claim 22, wherein the UE is arranged to operate compatibly on a 3rd Generation Partnership Project (3GPP) release 11 network.

30. The UE of claim 22, wherein the UE includes at least one of a speaker, a graphics processer, multiple radio antennas, or a touch screen.

31. The UE of claim 22, wherein the set of large scale parameters includes at least one of frequency offset compensation, signal-to-noise-ratio, Doppler delay profile, power delay profile, or channel estimation a member.

32. The UE of claim 22, wherein the UE assumes that the first set of antenna ports and the seconds set of antenna ports are quasi co-located based on the transmission mode.

33. A method performed by User Equipment (UE), the method comprising:
receiving signaling from a serving Evolved Node B (eNB) indicating a transmission mode for receiving a downlink channel, the transmission mode indicating that a first set of antenna ports and a second set of antenna ports are quasi co-located;
estimating a member of a set of large scale parameters for the first set of antenna ports, members of the set of large scale parameters including at least one of Doppler shift, Doppler spread, average delay, or delay spread; and
applying the estimated member of the set of large scale parameters to operations of the second set of antenna ports based on the indication of quasi co-location between the first set of antenna ports and the second set of antenna ports.

34. The method of claim 33, wherein the channel is an Enhanced Physical Downlink Control Channel (e-PDCCH), wherein the operations of the second set of antenna ports include decoding the e-PDCCH, and wherein members of the second set of antenna ports are antenna ports 107-110.

35. The method of claim 34, wherein members of the first set of antenna ports are antenna ports 0-3.

36. The method of claim 34, wherein the transmission mode is transmission mode 10, and wherein members of the first set of antenna ports are antenna ports 15-22.

37. The method of claim 33, wherein the signaling includes indication of a reference signal, and wherein estimating the member of the set of large scale parameters includes using the reference signal for the estimation.

38. The method of claim 37, wherein the reference signal is a channel-state information reference signal (CSI-RS).

39. The method of claim 37, wherein the indication of the reference signal includes a reference to a reference signal of a neighboring eNB

40. The method of claim 33, wherein the UE is arranged to operate compatibly on a 3rd Generation Partnership Project (3GPP) release 11 network.

41. The method of claim 33, wherein the UE includes at least one of a speaker, a graphics processor, multiple radio antennas, or a touch screen.

42. The method of claim 33, wherein the set of large scale parameters includes at least one of frequency offset compensation, signal-to-noise-ratio, Doppler delay profile, power delay profile, or channel estimation a member.

43. The method of claim 33, wherein the UE assumes that the first set of antenna ports and the seconds set of antenna ports are quasi co-located based on the transmission mode.

44. A machine readable medium that is not a transitory propagating signal, the machine readable medium included in User Equipment (UE) and including instructions that, when executed by the UE, cause the UE to perform operations comprising:
receiving signaling from a serving Evolved Node B (eNB) indicating a transmission mode for receiving a downlink channel, the transmission mode indicating that a first set of antenna ports and a second set of antenna ports are quasi co-located;
estimating a member of a set of large scale parameters for the first set of antenna ports, members of the set of large scale parameters including at least one of Doppler shift, Doppler spread, average delay, or delay spread; and
applying the estimated member of the set of large scale parameters to operations of the second set of antenna ports based on the indication of quasi co-location between the first set of antenna ports and the second set of antenna ports.

45. The machine readable medium of claim 44, wherein the channel is an Enhanced Physical Downlink Control Channel (e-PDCCH), wherein the operations of the second set of antenna ports include decoding the e-PDCCH, and wherein members of the second set of antenna ports are antenna ports 107-110.

46. The machine readable medium of claim 45, wherein members of the first set of antenna ports are antenna ports 0-3.

47. The machine readable medium of claim 45, wherein the transmission mode is transmission mode 10, and wherein members of the first set of antenna ports are antenna ports 15-22.

48. The machine readable medium of claim 44, wherein the signaling includes indication of a reference signal, and wherein estimating the member of the set of large scale parameters includes using the reference signal for the estimation.

49. The machine readable medium of claim 48, wherein the reference signal is a channel-state information reference signal (CSI-RS).

50. The machine readable medium of claim 48, wherein the indication of the reference signal includes a reference to a reference signal of a neighboring eNB

51. The machine readable medium of claim 44, wherein the UE is arranged to operate compatibly on a 3rd Generation Partnership Project (3GPP) release 11 network.

52. The machine readable medium of claim 44, wherein the UE includes at least one of a speaker, a graphics processor, multiple radio antennas, or a touch screen.

53. The machine readable medium of claim 44, wherein the set of large scale parameters includes at least one of frequency offset compensation, signal-to-noise-ratio, Doppler delay profile, power delay profile, or channel estimation a member.

54. The machine readable medium of claim 44, wherein the instructions cause the UE to assume that the first set of antenna ports and the seconds set of antenna ports are quasi co-located based on the transmission mode.
